(19) United States
(12) Patent Application Publication
(10) Pub. No.: US 2008/0002020 A1
(43) Pub. Date: Jan. 3, 2008

(54) APPARATUS AND METHOD FOR CONNECTING A VIDEO CALL IN A MOBILE COMMUNICATION SYSTEM

(75) Inventors: Woo-Young CHOI, Gyeyang-gu (KR); Wook-Hyun Jeong, Seoul (KR); Sung-Ik Park, Hwaseong-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/770,397

(22) Filed: Jun. 28, 2007

(30) Foreign Application Priority Data
Jun. 28, 2006 (KR) 2006-0058410

(51) Int. Cl. H04N 7/14; H04M 1/00

(52) U.S. Cl. 348/14.02; 455/550.1; 348/E07.077

(57) ABSTRACT

Provided are an apparatus and a method for connecting a vide call in mobile communication system. The method includes requesting video call profile data information of a receiving terminal from a profile information managing server while trying a video call; and connecting the receiving terminal for the video call by using the received profile data information when the video call profile information is received from the server. A video call connection can be promptly achieved between a transmitting terminal and a receiving terminal without a protocol negotiation procedure.

### PRIORITY

This application claims priority under 35 U.S.C. § 119 to an application entitled “Apparatus And Method For Connecting A Video Call In A Mobile Communication System” filed in the Korean Intellectual Property Office on Jun. 28, 2006 and assigned Serial No. 2006-58410, the contents of which are incorporated herein by reference.

### BACKGROUND OF THE INVENTION

1. Field of the Invention

The present invention relates generally to an apparatus and a method for connecting a video call in a mobile communication system, and in particular, to an apparatus and a method for connecting a video call, which register profile information of a video call terminal in advance and promptly connect the video call by using the registered profile information.

2. Description of the Related Art

International Mobile Telecommunications (IMT)-2000 system applied as a third generation (3G) mobile communication system constructs a world-wide wireless network to allow an undisclosed person to make a phone call wirelessly through a mobile phone at any location. A Wideband Code Division Multiple Access (WCDMA) mobile system based on a mobile communication network such as the IMT-2000, Universal Mobile Telecommunication System (UMTS), etc., is appropriate for high-speed data transmission, thereby providing a voice call, and a file and an image service such as an Internet service and a video call service to a user.

The video call service is provided by the H.324M international standard defined by the International Telecommunication Union (ITU) and is a terminal system protocol for a video call and conference. By using H.245 protocol, the video call service performs a negotiation process by exchanging information such as codec capability and logical channel between terminals, thereby connecting a video call.

FIG. 1 is a view illustrating an operation procedure for a video call connection between a transmitting terminal and a receiving terminal in a conventional mobile communication system.

Referring to FIG. 1, in step 110, when a transmitting terminal 100 performs a video call, a call set up is made in a receiving terminal 102. In step 112, the call is connected. Next, in step 114, the transmitting terminal 100 and the receiving terminal 102 exchange a call level determine signal that determines call quality and error correction. After exchanging signals including information for available voice codec and video codec capability in step 116, a signal for determining a master terminal and a slave terminal is exchanged in step 118. Next, the transmitting terminal 100 and the receiving terminal 102 transmit a response signal in response to a signal including information of an opposite terminal in step 120.

After exchanging the capability information, the transmitting terminal 100 and the receiving terminal 102 exchange logic channel open signals to generate a corresponding logic channel for transmitting and receiving voice as well as video data in steps 122 and 124, and then exchange a response signal in steps 126 and 130. Here, after exchanging the response signal for a logic channel open for the voice and image data, a corresponding data is transmitted and exchanged in steps 128 and 132, thereby making a video call possible.

As described above, exchanging profile information such as codec and logic channel between a transmitting terminal and a receiving terminal is complicated and it takes a long time to perform a negotiation procedure in the conventional mobile communication system. Thereafter, video calls are connected to each other Accordingly, since it takes a long time to connect a video call between the transmitting terminal and the receiving terminal due to the negotiation procedure, it is inconvenient for a user.

### SUMMARY OF THE INVENTION

An object of the present invention is to substantially solve at least the above problems and/or disadvantages and to provide at least the advantages described below. Accordingly, an object of the present invention is to provide an apparatus and a method for connecting a video call in a mobile communication system.

Another object of the present invention is to provide an apparatus and a method for connecting a video call by using video call profile information that is registered in a server within a mobile communication system.

Further another object of the present invention is to provide an apparatus and a method for reducing a video call connection time by using video call profile information registered in a server in a mobile communication system.

According to an aspect of the present invention, there is provided a method for connecting a video call in a terminal that includes requesting video call profile data information of a receiving terminal from a profile information managing server while attempting a video call; and connecting the receiving terminal for the video call by using the received profile data information upon receipt of the video call profile information from the server.

According to another aspect of the present invention, there is provided a method for connecting a video call in a terminal that includes requesting identification code information and profile version information of a receiving terminal from a profile information managing server while attempting a video call; searching a previous video call record having identification code information and profile version information received from the server; and connecting the video call by using previously stored video call profile data information when the previous video call record is available.

According to yet another aspect of the present invention, there is a method for operating a server that manages video call profile information that includes examining whether profile data information of a receiving terminal is requested from a transmitting terminal; and searching profile data information of the receiving terminal to transmit the information into the transmitting terminal upon request for the profile data information.

According to yet still another aspect of the present invention, there is provided a method for operating a server that manages video call profile information that includes searching an identification code and profile version information of a receiving terminal to transmit the information into a transmitting terminal upon request for the identification code and the profile version information from the transmitting terminal; and searching profile data of a terminal corresponding to the identification code to transmit the data into the transmitting terminal upon request for the profile data information of a terminal corresponding to the identification code is from the transmitting terminal.

According to still further another aspect of the present invention, there is provided a method for registering video call information of a terminal that includes transmitting subscription information into a video call information managing server for registration upon inserting a subscriber identify module; transmitting an identification code of the terminal into the server for registration upon receipt of a response signal for the subscriber identify information registration; and transmitting profile information of the terminal into the server for registration upon receipt of a response signal for the identification code registration.

According to yet still further another aspect of the present invention, there is provided a method for registering video call information in a server that includes registering requested subscription information upon requesting for registration of the subscription information from a terminal, and transmitting a signal signaling the registration of the subscription information into the terminal; registering a requested identification code upon requesting registration of the identification code from the terminal, and transmitting a signal for signaling the registration of the identification code into the terminal; and registering a requested profile information as profile information corresponding to the identification code upon requesting for registration of profile information form the terminal, and transmitting a signal for signaling the registration of the profile information into the terminal.

According to another aspect of the present invention, there is provided an apparatus for connecting a video call in a terminal that includes a control unit requesting a server for registration of subscription information and video call profile information upon inserting a subscriber identify module, requesting transmission of profile information about a server-side receiving terminal when a video call event occurs, and connecting the receiving terminal for a video call by using the available profile information among the received profile information; and a communication module for transmitting and receiving signals to and from a server according to a control of the control unit.

### BRIEF DESCRIPTION OF THE DRAWINGS

The above and other objects, features and advantages of the present invention will become more apparent from the following detailed description when taken in conjunction with the accompanying drawings in which:

FIG. 1 is a view illustrating an operation procedure for video call connection between a transmitting terminal and a receiving terminal in a conventional mobile communication system;

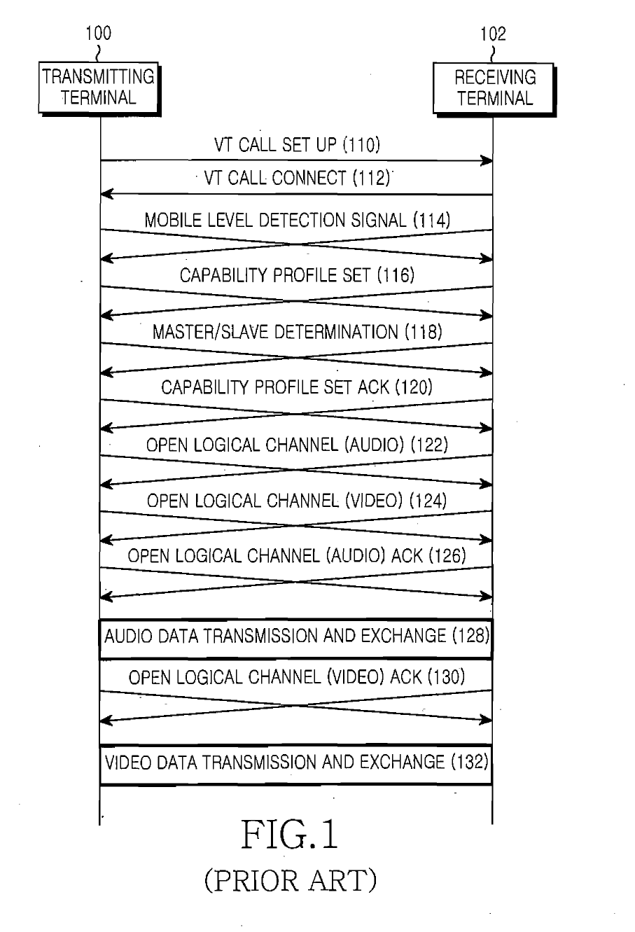

FIG. 2 is a diagram illustrating components of a mobile communication system supporting a video call according to the present invention;

FIG. 3 is a block diagram illustrating components of a mobile communication terminal according to the present invention;

FIG. 4 is a flow diagram that illustrates registering profile information in a mobile communication system according to the present invention;

FIG. 5 is a flow diagram that illustrates connecting a video call in a mobile communication system according to the present invention;

FIG. 6 is a flow chart illustrating an operation procedure of a terminal for a video call in a mobile communication system according to the present invention; and

FIGS. 7A to 7C are views illustrating a profile information table in a mobile communication system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides an apparatus and a method for connecting video call, which register profile information of a video call into a profile information server in advance and promptly connect a video call by using the registered profile information. The profile information server manages the profile information of a terminal for a video call connection. Hereinafter, the server will be described with an example of a home location register. Another device in the mobile communication system can register and manage the profile information.

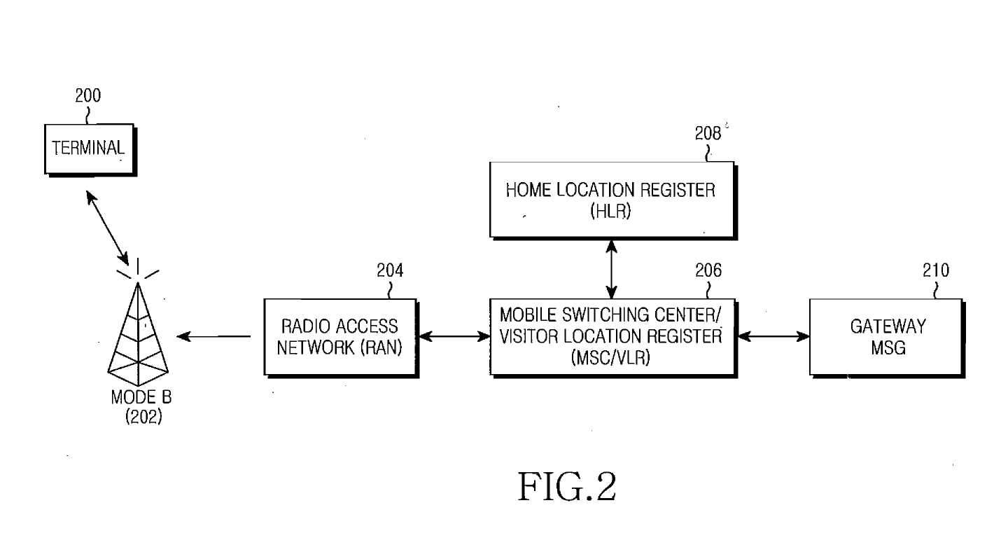

FIG. 2 is a diagram illustrating components of a mobile communication system supporting a video call according to the present invention. Here, the mobile communication system includes a terminal 200, node B 202, a Radio Access Network (RAN) 204, a mobile switching center/visitor location register (“a mobile switching center”) 206, a Home Location Resistor (HLR) 208, and a gateway MSG 210.

Referring to FIG. 2, the terminal 200 transmits subscription information, terminal IDentification (ID) and video call information into the mobile switching center 206 and requests the transmitted information to be registered in the home location resistor 208 when a subscriber identify module is inserted. Here, the terminal ID represents an identification code of a terminal supporting a video call service. The video call profile information represents a profile information version and profile data information. The profile data information represents voice codec information, video codec information, and local channel information that the terminal supports. Additionally, the terminal 200 requests the receiving terminal ID and profile information from the home location register 206 that manages the receiving terminal for video call connection through the mobile switching center 206. Then, the terminal 200 receives a corresponding response signal, thereby performing a video call with the receiving terminal.

The node B 202 functions as a base station to provide a wireless communication service to a subscriber. The radio access network 204 is a sub-system of the node B 202 and performs widely ranged functions such as connection to the Internet and a public switched telephone network, roaming, transparent connection, and service quality management about data and web connection for third generation (3G) mobile communication subscribers.

The mobile switching center is a mobile communication switcher for providing a mobile communication service to a subscriber, having functions such as circuit switching between subscribers, input and output relay processing, handoff, roaming, etc., and managing a database for a visitor location register. Here, the visitor location register detects a terminal to perform a roaming function with other systems when the terminal of another system enters a coverage area. The mobile switching center 206 transmits subscription information, terminal ID, profile information into the home location register 208 for registration, upon request for the information from the terminal 200.

The home location register 208 is a data base center that manages the current position information of the terminal, the status of the mobile communication subscriber, statistics, and various service related information. Additionally, the home location register 208 provides various additional functions such as a digest message service, and authentication service, etc., and works with another switching function. Especially, upon request for profile information of a terminal having a specific ID from the terminal 200, video call profile information corresponding to the ID is transmitted into the terminal because the ID and the profile information of the video call terminal are registered in advance.

The gateway Mobile Switching Center (MSC) 210 mutually connects different or identical communication networks to exchange information between communication networks.

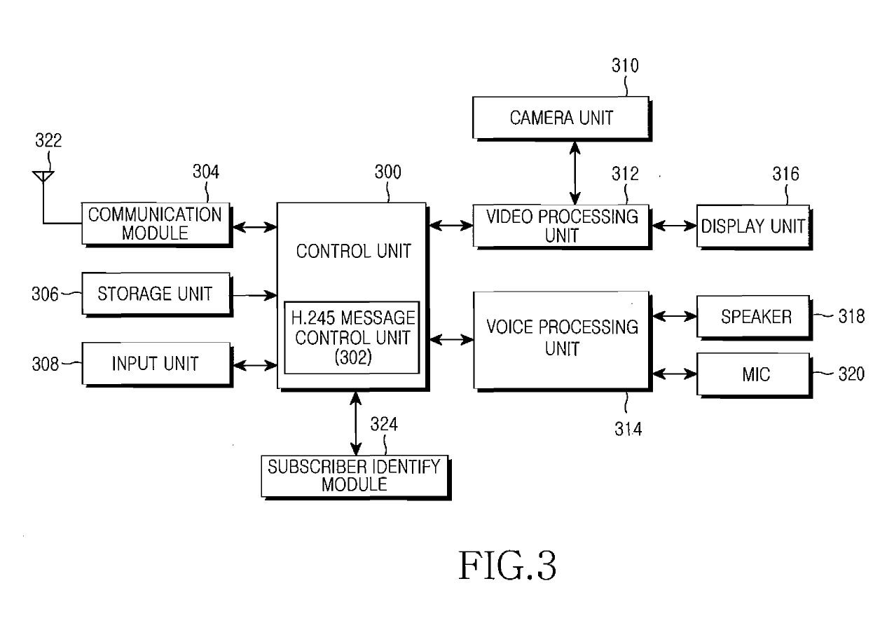

FIG. 3 is a block diagram illustrating components of a mobile communication terminal according to the present invention. The mobile communication terminal includes a controller 300, an H.245 message control unit 302, a communication module 304, a storage unit 306, an input unit 308, a camera unit 310, an image processing unit 312, a voice-processing unit 314, a display unit 316, a speaker 318, a MICrophone (MIC) 320, an antenna 322, and a subscriber identify module 324.

Referring to FIG. 3, the control unit 300 performs processing and controlling for a voice call and data communication of a mobile communication terminal, particularly upon detecting whether the subscriber identify module is inserted. When the subscriber identify module is inserted, a function of registering subscriber information, terminal ID, and video call profile information in the home location register is controlled. Additionally, the video call events occur, a function of connecting the receiving terminal for a video call is controlled by requesting the terminal ID and the profile information. Here, the control unit 300 includes the H.245 message control unit 302 to process and control an H.245 message transmitted and received with the home location register.

The communication module 304 processes a radio signal of data inputted and outputted through the antenna 322. For example, in a case of transmitting, data that will be transmitted is transmitted through the antenna by converting a channel coding and spreading base band signal into a Radio Frequency (RF) signal. In a case of receiving, the data is restored by converting the received RF signal into the base band signal, and de-spreading as well as channel de-coding the base band signal.

The storage unit 306 stores ID information, profile information, etc. in a terminal that performs a video call. The input unit 308 includes a plurality of function keys and provides data corresponding to a user key input into the control unit 300.

The camera unit 310 includes a camera sensor for converting a light signal detected during image photographing into an electric signal, and a signal processing unit for converting an analog image signal photographed by the camera sensor into digital data. The camera unit 310 outputs the image signal converted into digital data into the image-processing unit 312.

The image-processing unit 312 is called a coder-decoder (CODEC). The image-processing unit 312 codes an image signal in a predetermined way, or decodes the coded frame image data into original frame image data. Moreover, the image signal outputted from the camera unit 310 is processed by frame unit to output according to the characteristic and size of the display unit 316.

The voice-processing unit 314 is called a voice CODEC. The voice-processing unit 314 processes input and output of a voice signal through a MIC 320 and a speaker 318 connected to the voice-processing unit 314. For example, Pulse Code Modulation (PCM) data provided from the control unit 300 is converted into an analog voice signal for outputting through the speaker 318. A voice signal applied from the MIC 320 is converted into PCM data to provide the PCM data into the control unit 300.

The display unit 316 displays status information generated during an operation of the mobile communication terminal, and the limited number of letters. The subscriber identify module 324 is detachable from the mobile communication terminal, and includes a microprocessor and a memory chip in itself to store various user information.

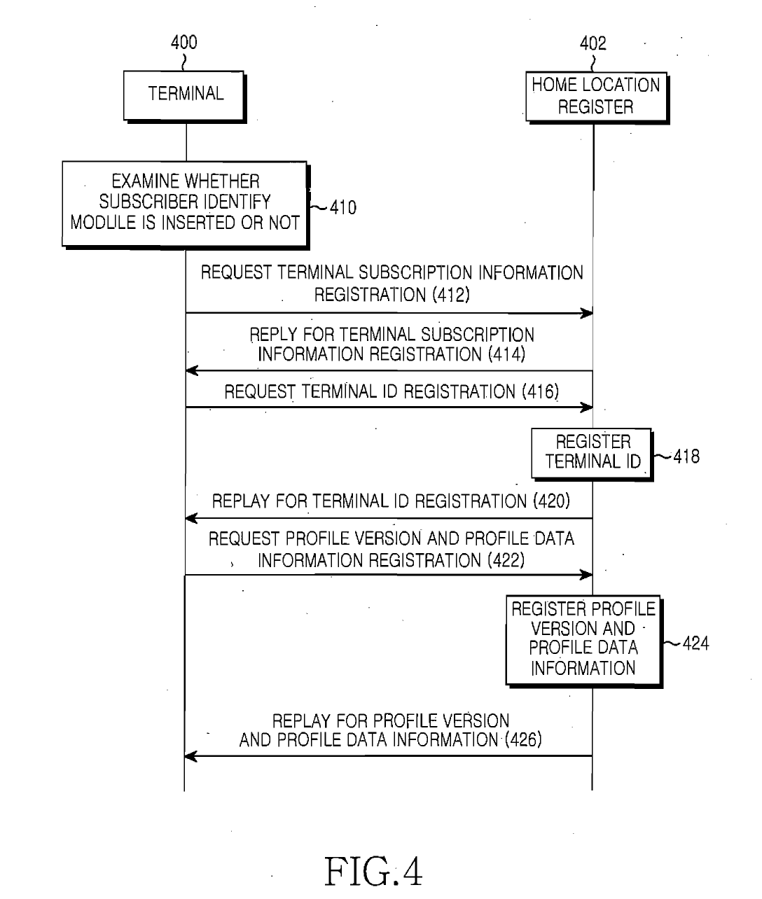

FIG. 4 is a flow diagram that illustrates registering profile information in a mobile communication system according to the present invention. Signals that are transmitted or received between the terminal and the home location register are transmitted or received through the mobile switching center.

Referring to FIG. 4, the terminal 400 detects whether subscriber/international subscriber identify module is inserted in step 410. When the subscriber identify module is inserted, a message including subscription information recoded in the subscriber identify module is transmitted into the home location register 402 to request registration of the terminal subscription information in step 412. The home location register 402 upon receiving a request for registration of the subscription information registers the subscription information of the terminal, and transmits a response signal into the terminal 400 in step 414.

Next, the terminal 400 transmits the ID for signaling that the terminal 400 is a terminal supporting a video call service into the home location register 402 to request registration of the ID in step 416. The home location register 402 receiving the ID registration registers the requested terminal ID in step 418, and transmits a response message into the terminal 400 in step 420. Here, the home location register 402 determines whether the ID is registered. When the ID is previously-registered, the home location register 402 immediately transmits a response message, and when the ID is un-registered, it transmits a response message after registering the ID, thereby minimizing a registration process.

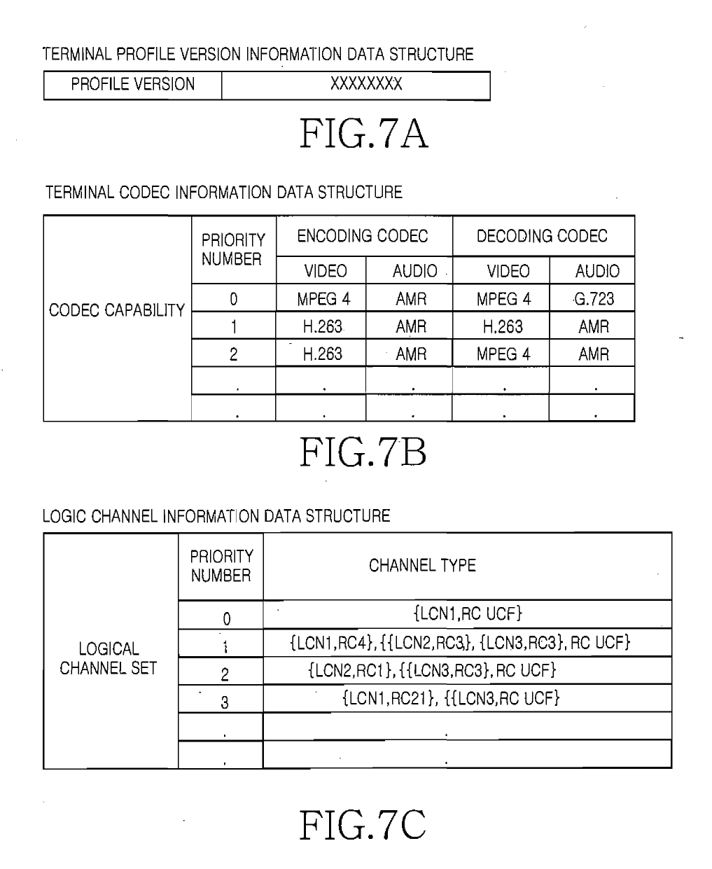

Next, the terminal 400 transmits the video call profile information that the terminal supports, i.e., a profile version and the profile data information, into the home location register 402 to request for registration in step 422. Here, the profile version is a value representing whether the profile information is updated, and can be displayed as eight bit data, as shown in FIG. 7A. Additionally, the profile data information is voice and video codec information and logic channel information that the terminal can support. As illustrated in FIGS. 7B and 7C, when there is more than one profile data information that the terminal can support, a priority order can be set on each information.

Next, the home location register 402 determines whether a profile version corresponding to the ID of the terminal is registered Upon determining that the profile version is un-registered, the home location register 402 registers the profile version requested for registration from he terminal and profile data information in step 424, and then transmits a response message into the terminal 400 in step 426 When the profile version corresponding to the ID is previously-registered, the home location register 402 determines whether the profile version requested for registration corresponds to a previously-registered profile version. When the profile version is identical to the previously registered profile version, the home location register 402 does not register the requested profile version and the data information, and then transmits a respond message into the terminal 400 in step 426. Alternatively, when the profile version is not identical to the previously-registered profile version, the home location register 402 registers the profile version requested for registration and the profile data information in step 424, and then transmits a respond message into the terminal 400 in step 426.

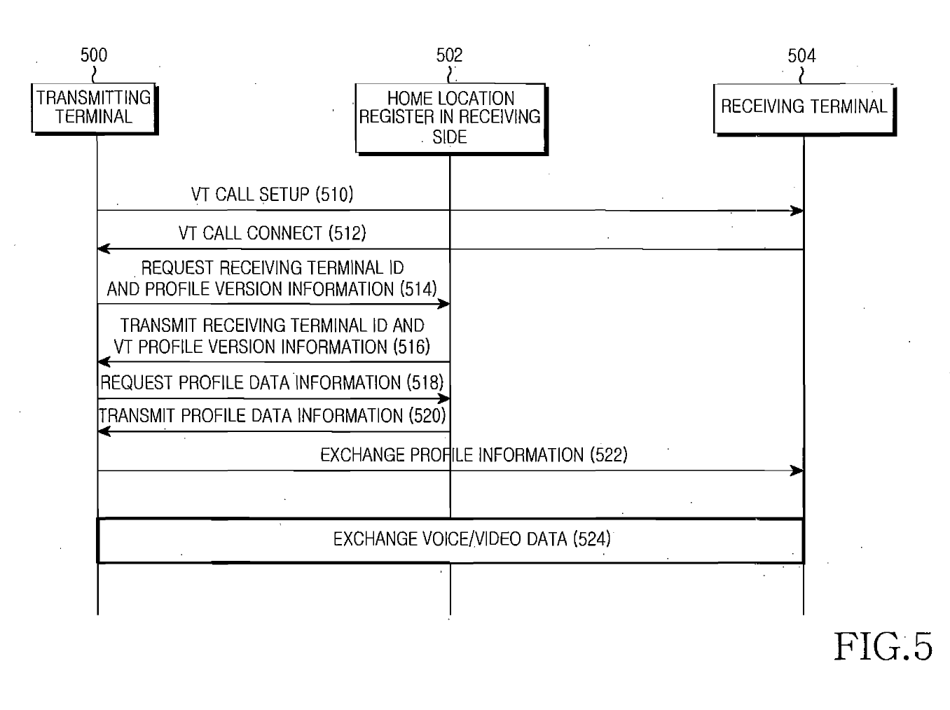

FIG. 5 is a flow diagram that illustrates connecting a video call in a mobile communication system according to the present invention. Signals that are transmitted or received between the terminal and the home location register are transmitted or received through the mobile switching center.

Referring to FIG. 5, when a transmitting terminal 500 requests a call set up for a video call connection from a receiving terminal 504 in step 510, the receiving terminal 504 connects a call for a video call with the transmitting terminal 500 in step 512.

Next, when the transmitting terminal 500 requests the receiving terminal ID and the profile version from the receiving-side home location register 502 managing the profile information of the receiving terminal 504 in step 514, the home location register 502 transmits the ID and the profile version of the receiving terminal 504 into the transmitting terminal 500 in step 516.

Next, when the transmitting terminal 500 requests profile data information in step 518, the home location register 502 that is requested for the profile data information transmits more than one profile data information into the transmitting terminal 500 in step 502.

The transmitting terminal 500 receiving the profile data information of the receiving terminal 504 selects CODEC and logic channel that perform a video call among the received profile data information, and then transmits the selected codec and logic channel information into the receiving terminal 504 in step 522.

Next, the transmitting terminal 500 and the receiving terminal 504 perform a video call connection by using the selected codec and the logic channel information in step 524.

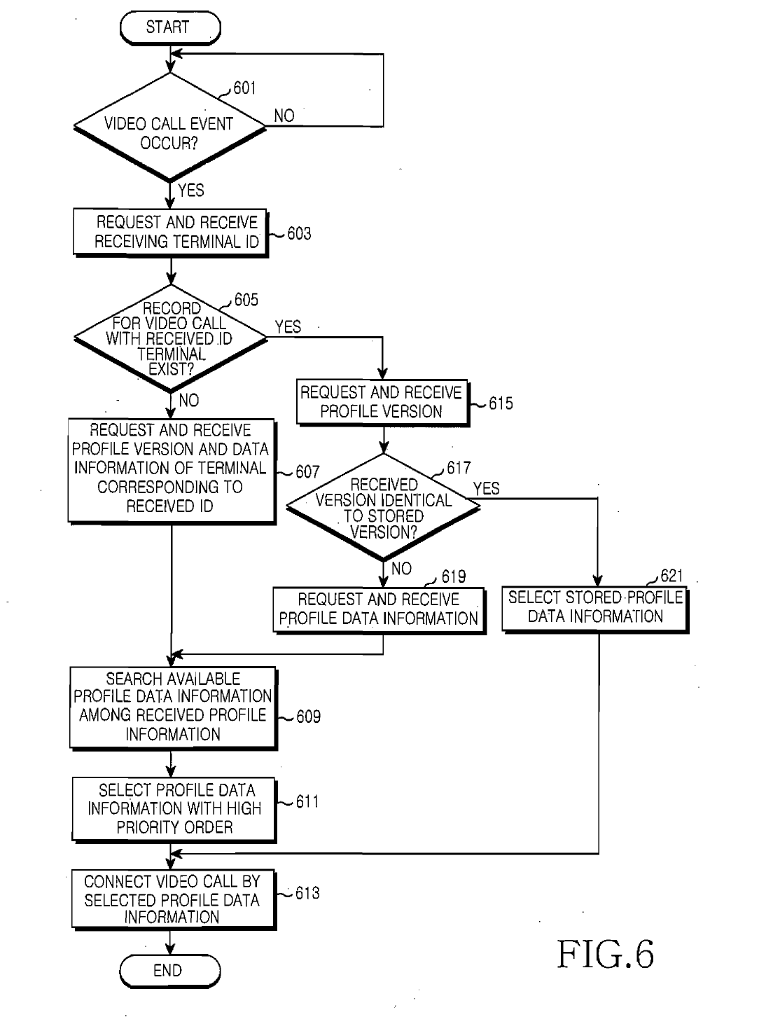

FIG. 6 is a flow chart illustrating an operation procedure of a terminal for a video call in a mobile communication system according to the present invention. Referring to FIG. 6, the terminal detects whether an event for a video call occurs in step 601. When the video call event occurs, the terminal requests the receiving terminal ID from the home location register of the receiving terminal, and then receives the terminal ID from the home location register in step 603. Here, the terminal ID represents an original identification code of a terminal supporting a video call service.

Next, the terminal determines whether the received ID exists in the storage unit 306, and examines whether a previous record for a video call with the terminal corresponding to the ID exists in step 605. Here, the video call record includes the terminal ID, a profile version, and the selected profile data information. The profile version represents a value of whether the profile information is updated. The selected profile data information represents codec information and logic channel information used in connection between the receiving terminal and the video call.

When there is no receiving terminal ID in the storage unit 306, i.e., no record for a video call with the receiving terminal, the terminal requests profile information, i.e., the profile version and profile data information, of the receiving terminal corresponding to the received ID from the home location register, and then receives the profile version and the profile data information in step 607.

Next, the terminal searches the profile data information that the terminal can support among the received profile data information in step 609, and selects the profile data information in a high priority order among the searched profile data information in step 611. For example, when the codec information that the terminal can support is a video codec: MPEG 4/H.263 and a voice codec: AMR, and the received profile codec information of the receiving terminal is identical to that of FIG. 7(B), codec information of the high priority order can be selected by identifying that a priority order 1 and 2 are supported. At this point, the terminal stores the receiving terminal ID, the profile version, and the selected profile data information in the storage unit 306.

Next, the terminal informs the receiving terminal to perform a video call by using the selected profile data information in step 613. Then, the process of the present invention terminates.

Alternatively, when there is the receiving terminal ID in the storage unit 306, i.e., a record for a video call with the receiving terminal, the terminal receives the profile version by requesting a profile version corresponding to the ID from the home location register in step 615.

Next, the terminal determines whether the received profile version is identical to the profile version stored in the storage unit 306 in step 617 when the received profile version is identical to the recoded profile version, the terminal determines that the video call profile data information of the receiving terminal is unchanged, and then selects the profile data information recoded in the storage unit 306 in step 612. It then proceeds to the step 613. Alternatively, when the received profile version is not identical to the recoded profile version, the terminal determines that the video call profile data information of the receiving terminal is changed, requests the profile data information of the receiving terminal from the home location register, and receives the profile data information in step 619. It then proceeds to the step 609.

As described above, the present invention registers video call profile information into a server and performs a video call connection between terminals by using the registered information when a subscriber identify module is inserted into a terminal in a mobile communication system. Therefore, a rapid video call can be achieved without a protocol negotiation procedure.

While the invention has been shown and described with reference to certain preferred embodiments thereof it will be understood by those skilled in the art that various changes in form and details may be made therein without departing from the spirit and scope of the invention as defined by the appended claims.

What is claimed is

1. A method for connecting a video call in a terminal, the method comprising the steps of:
requesting video call profile data information of a receiving terminal from a profile information managing server while trying a video call; and
connecting the receiving terminal for the video call by using the received profile data information when the video call profile information is received from the server.

2. The method of claim 1, wherein the profile data information comprises at least one of voice codec information, video codec information, logic channel information, and a priority order in each information that the terminal supports.

3. The method of claim 1, wherein the connecting of the receiving terminal for the video call comprises selecting available profile data information among the received profile data information to transmit the information into the receiving terminal.

4. The method of claim 3, wherein the selecting of the profile data information comprises, when more than one available profile data information is searched in the received profile data information, selecting profile data information having the highest priority order.

5. A method for connecting a video call in a terminal, the method comprising the steps of:
requesting identification code information and profile version information of a receiving terminal from a profile information managing server while trying a video call;
searching a previous video call record having identification code information and profile version information received from the server; and
connecting the video call by using stored video call profile data information when there is the previous video call record.

6. The method of claim 5, further comprising
requesting profile data information of a terminal corresponding to the identification code from the server when there is no previous video call record; and
connecting the video call by using the profile data information received from the server.

7. The method of claim 6, wherein the connecting of the video call comprises using profile data information having the highest priority order among searched profile data information when more than one available profile data information is searched among the received profile data information.

8. The method of claim 6, wherein the previously received profile data information comprises at least one of voice codec information, video codec information, logic channel information, and a priority order in each information.

9. The method of claim 5, wherein the previously stored profile data information comprises at least one voice codec information, video codec information, and logic channel information that are used in a previous video call.

10. A method for operating a server that manages video call profile information, the method comprising the steps of:
examining whether profile data information of a receiving terminal is requested from a transmitting terminal; and
searching profile data information of the receiving terminal to transmit the information into the transmitting terminal when the profile data information is requested.

11. The method of claim 10, wherein the profile data information comprises at least one of voice codec information, video codec information, logic channel information, and each having a priority order.

12. A method for operating a server that manages video call profile information, the method comprising the steps of:
searching an identification code and profile version information of a receiving terminal to transmit the information into a transmitting terminal when the identification code and the profile version information are requested from the transmitting terminal; and
searching profile data of a terminal corresponding to the identification code to transmit the data into the transmitting terminal when profile data information of a terminal corresponding to the identification code is requested from the transmitting terminal.

13. The method of claim 12, wherein the profile data information comprises at least one of voice codec information, video codec information, logic channel information, and a priority order in each information.

14. A method for registering video call information of a terminal, the method comprising the steps of:
transmitting subscription information into a video call information managing server for registration when a subscriber identify module is inserted;
transmitting an identification code of the terminal into the server for registration when a response signal for the subscriber identify information registration is received; and
transmitting profile information of the terminal into the server for registration when a response signal for the identification code registration is received.

15. The method of claim 14, wherein the profile information comprises at least one of a profile information version, voice codec information, video codec information, logic channel information, and each having a priority order.

16. A method for registering video call information in a server, the method comprising the steps of:
registering requested subscription information when registration of the subscription information is requested from a terminal, and transmitting a signal signaling the registration of the subscription information into the terminal;
registering a requested identification code when registration of the identification code is requested from the terminal, and transmitting a signal signaling the registration of the identification code into the terminal; and
registering requested profile information as profile information corresponding to the identification code when registration of profile information is requested form the terminal, and transmitting a signal signaling the registration of the profile information into the terminal.

17. The method of claim 16, wherein the transmitting of the signal signaling the registration of the identification code comprises:
examining whether the requested identification code is a previously registered identification code; and
registering the identification code when the requested identification code is not a previously registered identification code, and transmitting a signal signaling the registration of the identification code into the terminal.

18. The method of claim 17, further comprising transmitting a signal signaling the registration of the identification code into the terminal without registering the identification code when the requested identification code is a previously registered identification code.

19. The method of claim 16, wherein the transmitting of the signal signaling the registration of the profile information comprises:
examining whether profile information corresponding to the identification code is previously registered profile information; and
registering requested profile information as profile information corresponding to the identification code when the profile information is the previously registered profile information, and transmitting a signal signaling the registration of the profile information into the terminal.

20. The method of claim 19, further comprising transmitting a signal signaling the registration of the profile information into the terminal without registering the profile information when the profile information is previously registered profile information.

21. The method of claim 16, wherein the profile information comprises at least one of a profile information version, voice codec information, video codec information, logic channel information, and each having a priority order.

22. An apparatus for connecting a video call in a terminal, the apparatus comprising:
a control unit for requesting a server for registration of subscription information and video call profile information when a subscriber identify module is inserted, requesting transmission of profile information about a server-side receiving terminal when a video call event occurs, and connecting the receiving terminal for a video call by using available profile information among received profile information; and
a communication module for transmitting and receiving signals to and from the server according to a control of the control unit.

23. The apparatus of claim 22, wherein the control unit comprises a H.245 message control unit processing and controlling a H.245 message transmitted to and received from the server to connect the video call.

24. The apparatus of claim 22, further comprising a storage unit storing information of the receiving terminal that performs the video call.

25. The apparatus of claim 24, wherein the receiving terminal comprises at least one of an identification code of the terminal, a profile version, and profile data information used for video call connection.

26. The apparatus of claim 22, wherein the profile information comprises at least one of an identification code, a profile version, voice codec information, image codec information, logical channel information, and each having a priority order.

27. An apparatus for connecting a video call in a mobile communication system, the apparatus comprising:
a receiving terminal for registering video call profile information in a video call information managing server;
the video call information managing server for registering the image call profile information of the receiving terminal for management; and
a transmitting terminal for requesting video call profile information of the receiving terminal from the video call information managing server when a video call event occurs, and performing a video call with the receiving terminal by using the information.

28. The apparatus of claim 27, wherein the profile information comprises at least one of subscription information of the terminal, an identification code, a profile information version, voice codec information, video codec information, logic channel information and each having a priority order.

29. A mobile communication terminal for connecting a video call, comprising:
means for requesting video call profile data information of a receiving mobile communication terminal from a profile information managing server while trying a video call; and
means for connecting the receiving terminal for the video call by using the received profile data information.

30. A mobile communication terminal for connecting a video call, comprising:
a means for requesting identification code information and profile version information of a receiving communication terminal from a profile information managing server;
a means for searching a previous video call record having identification code information and profile version information received from the server; and
a means for connecting the video call by using stored video call profile data information when there is the previous video call record.

31. A mobile communication terminal for registering video call information of the terminal, comprising:
a means for transmitting subscription information into a video call information managing server for registration when a subscriber identify module is inserted;
a means for transmitting an identification code of the terminal to the server for registration when a response signal for the subscriber identify information registration is received; and
a means for transmitting profile information of the terminal to the server for registration when a response signal for the identification code registration is received.
